(19) United States
(12) Patent Application Publication
(10) Pub. No.: US 2016/0270384 A1
(43) Pub. Date: Sep. 22, 2016

(54) BUCKET MOUNTED LURE HANGING RING

(71) Applicant: Scott Wellington Sato, Kaneohe, HI (US)

(72) Inventor: Scott Wellington Sato, Kaneohe, HI (US)

(21) Appl. No.: 14/660,861

(22) Filed: Mar. 17, 2015

(51) Int. Cl. A01K 97/06; F16M 13/02

(52) U.S. Cl. CPC A01K 97/06; F16M 13/02

(57) ABSTRACT

A lure hanging ring for use in a conventional bucket to hang conventional fishing lures or a fishing apparatus having a hook comprises a circular ring member having four attachment members integral therewith. The ring member defines a rigid circular bar that is sized to receive the hook of a conventional fishing lure or other fishing apparatus having a hook such that the fishing apparatus can hang therefrom. The attachment members each define an identical “L” shaped body permanently attached to the ring member at one end and having a mounting portion at the other end. The lure hanging ring is sized to fit inside a conventional bucket such that its attachment members can contact the side wall of the bucket upon its placement therein and be fastened therein through the passing of an elongated fastener through the attachment member and the side wall.

### BRIEF DESCRIPTION OF THE DRAWINGS

FIG. 1 is a bottom plan view of a lure hanging ring built in accordance the present invention.

FIG. 2 is a side perspective view of a lure hanging ring built in accordance the present invention in a down orientation.

FIG. 3 is a partial side perspective view of a lure hanging ring built in accordance the present invention in an up orientation.

FIG. 4 is a top perspective view of a lure hanging ring mounted on a conventional bucket in accordance the present invention.

FIG. 5 is a top plan view of a lure hanging ring mounted on a conventional bucket in accordance the present invention with conventional fishing lures hung therefrom.

### DETAILED DESCRIPTION OF THE INVENTION

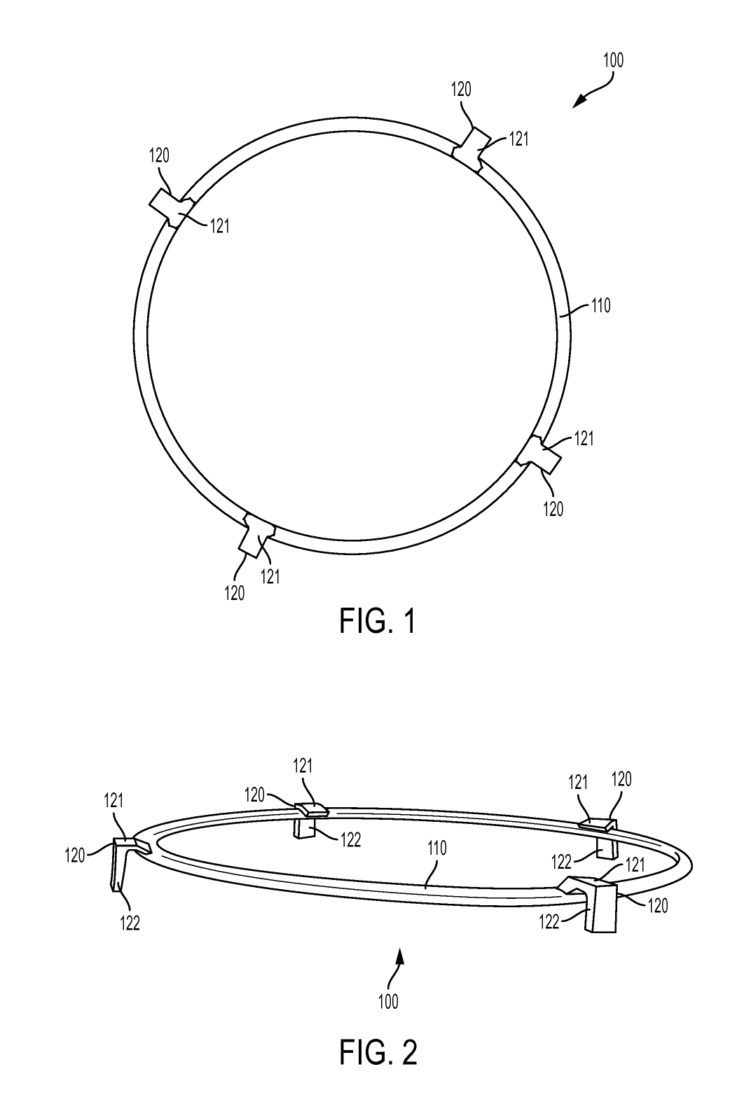

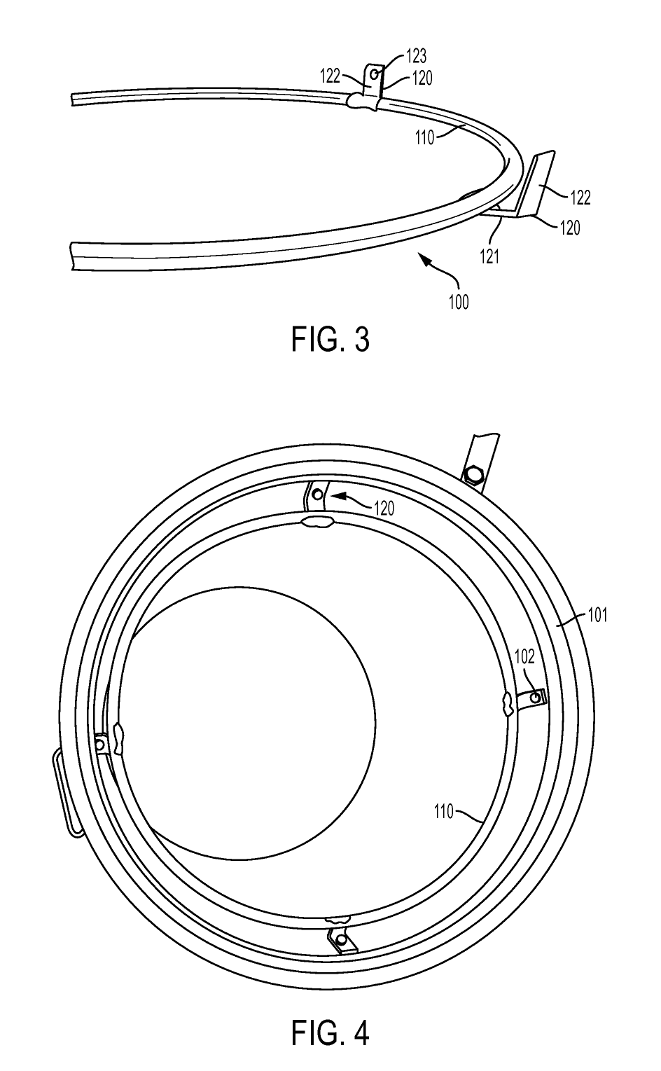

Referring now to the drawings and in particular FIGS. 1, 2, and 3, a lure hanging ring 100 is shown as a circular ring member 110 having four attachment members 120 integral therewith. It is contemplated that the lure hanging ring 100 is sized to fit inside a conventional bucket such that its attachment members 120 can contact the side wall of the bucket upon its placement therein. It is appreciated that many conventional buckets have side walls that are tapered; and when employed with tapered wall buckets it is contemplated that the lure hanging ring 100 will be sized to contact the side wall near the top rim of the bucket so as to provide sufficient space in the bucket below the lure hanging ring 100 for objects that are hanging therefrom.

The ring member 110 defines a rigid circular bar that is sized to receive the hook of a conventional fishing lure or other fishing apparatus having a hook such that the fishing apparatus can hang therefrom. In the preferred embodiment, the ring member 110 is constructed of a corrosion resistant metal substance, such as stainless steel or aluminum, as it is appreciated that during its contemplated use, the ring member 110 will routinely be exposed to water. It is contemplated, however, that in alternate embodiments the ring member 110 may be constructed of other rigid, corrosion resistant (or decay resistant) substances such as plastic or treated wood.

The four attachment members 120 each define an identical “L” shaped body defining a horizontal planar surface 121 and a vertical planar surface 122. The end of the horizontal planar surface 121 distal to the vertical planar surface 122 is permanently attached to the ring member 110. In the preferred embodiment, it is understood that the attachment members 120 are attached to the bottom surface of the ring member 110, thereby enabling fishing lures that are hanging therefrom to slide freely completely around the ring member 110. In an alternate embodiment, the attachment members 120 are attached to the top or side surface of the ring member 110 to partially or fully restrict the ability of fishing lures that are hanging from the ring member 110 to slide freely around the ring member 110 when such a configuration is desired.

In the preferred embodiment, the vertical planar surface 122 includes an mounting aperture 123 therein that is sized to receive a conventional elongated fastener, such as a nail, screw or bolt (not shown), thereby enabling the attachment members 120 to be attached to the internal wall of a conventional bucket by passing the fastener through its mounting aperture 123 and the wall of the bucket. In alternate embodiments, as illustrated in FIG. 2, the vertical planar surface 122 defines a solid flat planar surface that can be attached to the internal wall of a conventional bucket through an adhesive. It is contemplated, however, that an adhesive may be used in addition to or in the alternative of an elongated fastener for the preferred embodiment attachment members 120 (those having a mounting aperture 123).

In the preferred embodiment, the attachment members 120 are constructed of the same material as the ring member 110 and are welded or soldered thereto to ensure a permanent attachment. It is contemplated, however, that if the attachment members 120 may alternatively be constructed of alternate corrosive resistant materials (or decay resistant) and may be molded with or adhered to the ring member 110 in order to ensure optimally attachment depending on the materials the components are constructed of.

Each of the attachment members 120 are disposed on the ring member 110 around its circumference at a position that, relative to one another, defines 90 degrees, 180 degrees, and 270 degrees. It is appreciated that the attachment members 120 being equally spaced around the circumference of the ring member 110 provides maximum structural stability for hanging fishing lures across the entire for the lure hanging ring 100 when in place on a conventional bucket.

In alternate embodiments, the lure hanging ring 100 may include three attachment members 120 disposed on the ring member 110 around its circumference at a position that, relative to one another, defines 120 degrees and 240 degrees, or include two attachment members 120 disposed on the ring member 110 around its circumference at a position that, relative to the other, defines 180 degrees, or include five attachment members 120 disposed on the ring member 110 around its circumference at a position that, relative to one another, defines 72 degrees, 144 degrees, 216 degrees, and 288 degrees, or include another number of attachment members 120 that defines a plurality disposed on the ring member 110 equally spaced around its circumference.

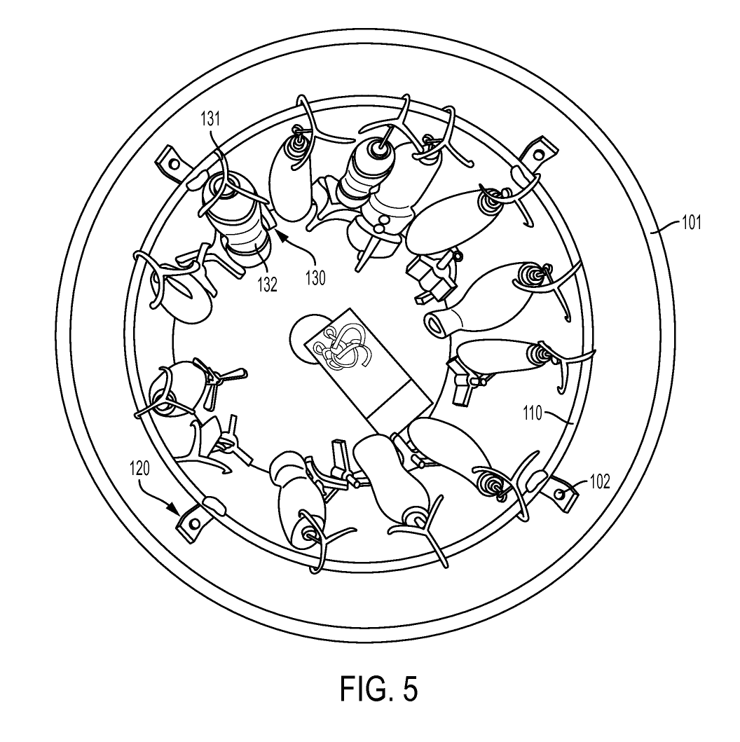

Referring now to FIGS. 1, 2, 3, 4, and 5, the preferred embodiment of the lure hanging ring 100 is mounted to a conventional bucket 101 by first placing it in inside the bucket 101 with the vertical planar surface 122 of each attachment members 120 adjacent to or in contact with the inside surface of the bucket's 101 side wall. A conventional elongated fastener 102 is then passed through mounting apertures 123 on the attachment members 120 and the bucket's 101 side wall, thereby fastening the attachment members 120 to the bucket's 101 side wall. Once the attachment members 120 have been fastened to the bucket's 101 side wall, the lure hanging ring 100 is ready to use, which typically will entail the hanging a conventional fishing lure 130, or a fishing apparatus having a hook, by placing its hook 131 on the ring member 110 such that it supports the body 132 of the fishing lure 130 below the ring member 110 in the bucket 101.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. A lure hanging ring for mounting in a conventional bucket, comprising:
a hanging member sized to receive the hook of a conventional fishing lure;
at least one attachment member integral with said hanging member, wherein said attachment member is adapted contact the side wall of a conventional bucket upon the placement of the lure hanging ring therein; and
said at least one attachment member is configured to be fastened to the side wall of a conventional bucket so as to facilitate the mounting of the lure hanging ring in the conventional bucket.

2. The lure hanging ring of claim 1, wherein the hanging member defines a rigid circular bar.

3. The lure hanging ring of claim 1, wherein a plurality of attachment members are integral with said hanging member, spaced equal distances from one another.

4. The lure hanging ring of claim 1, wherein four attachment members are integral with said hanging member.

5. The lure hanging ring of claim 1, wherein the at least one attachment members are each defined by an L shaped body.

6. The lure hanging ring of claim 5, wherein said hanging member includes a bottom surface and each of the at least one attachment members is integral with the hanging member through being permanently attached to the bottom surface.

7. The lure hanging ring of claim 1, wherein the at least one attachment members each include a mounting aperture sized to receive a conventional elongated fastener and the at least one attachment member is configured to be fastened to the side wall of a conventional bucket by passing the fastener through said mounting aperture and the side wall of a conventional bucket.

8. A lure hanging ring for mounting in a conventional bucket, comprising:
a circular ring member defining a rigid circular bar sized to receive the hook of a conventional fishing lure;
at least one attachment member defined by an L shaped body having a horizontal side and a vertical side, wherein the horizontal side is integral with said ring member and the vertical side is adapted contact the side wall of a conventional bucket on the other side upon the placement of the lure hanging ring therein; and
said at least one attachment member is configured to be fastened to the side wall of a conventional bucket so as to facilitate the mounting of the lure hanging ring in the conventional bucket.

9. The lure hanging ring of claim 8, wherein a plurality of attachment members are integral with said ring member, spaced equal distances from one another around the circumference thereof.

10. The lure hanging ring of claim 8, wherein four attachment members are integral with said ring member.

11. The lure hanging ring of claim 8, wherein said ring member includes a bottom surface and each of the at least one attachment members is integral with the ring member through being permanently attached to the bottom surface.

12. The lure hanging ring of claim 8, wherein the vertical side of the at least one attachment member is adapted to be adhered to the side wall of a conventional bucket through a topical adhesive.

13. The lure hanging ring of claim 8, wherein the at least one attachment members each include a mounting aperture on the vertical side sized to receive a conventional elongated fastener and the at least one attachment member is configured to be fastened to the side wall of a conventional bucket by passing the fastener through said mounting aperture and the side wall of a conventional bucket.

14. A method of storing conventional fishing lures in a conventional bucket, comprising the steps of:
providing a lure hanging ring defining a hanging member sized to receive the hook of a conventional fishing lure and at least one attachment member integral with said hanging member, wherein said attachment member is adapted contact the side wall of a conventional bucket upon the placement of the lure hanging ring therein;
fastening said at least one attachment member to the side wall of a conventional bucket in a position such that the hanging member is spaced sufficiently from the bottom of the bucket for objects to hang therefrom, thereby mounting the lure hanging ring in the conventional bucket; and
hanging a fishing apparatus having a hook from the hanging member.

15. The method of claim 14, wherein the hanging member defines a rigid circular bar.

16. The method of claim 14, wherein a plurality of attachment members are integral with said hanging member, spaced equal distances from one another.

17. The method of claim 14, wherein four attachment members are integral with said hanging member.

18. The method of claim 14, wherein the at least one attachment member is defined by an L shaped body.

19. The method of claim 18, wherein said hanging member includes a bottom surface and each of the at least one attachment members is integral with the hanging member through being permanently attached to the bottom surface.

20. The method of claim 14, wherein the at least one attachment members each include a mounting aperture sized to receive a conventional elongated fastener and the step of fastening said at least one attachment member to the side wall of a conventional bucket is defined by passing a conventional elongated fastener through said mounting aperture and the side wall of a conventional bucket.
